(19) United States
(12) Patent Application Publication
(10) Pub. No.: US 2009/0314767 A1
(43) Pub. Date: Dec. 24, 2009

(54) ELECTRICAL HEATING ELEMENT

(76) Inventors: Jie-Wei Chen, Alpnach Dorf (CH); Alexander Greber, Eich (CH)

Correspondence Address: MARK D. SARALINO (GENERAL);RENNER, OTTO, BOISSELLE & SKLAR, LLP, 1621 EUCLID AVENUE, NINETEENTH FLOOR, CLEVELAND, OH, 44115-2191, US

(21) Appl. No.: 12/282,389

(22) PCT Filed: Jan. 25, 2007
(86) PCT No.: PCT/EP07/00614

§ 371 Date: Dec. 24, 2008

(30) Foreign Application Priority Data
Apr. 8, 2006 (DE) 10 2006 016 695.7

(51) Int. Cl. H05B 3/14

(52) U.S. Cl. 219/553

(57) ABSTRACT

An electrical heating element, in particular for a hot-wedge film welding device, having two electrodes and a heating resistor arranged between the electrodes such that an application of an electrical voltage to the electrodes results in heat being produced along the length of the heating resistor. The heating resistor is designed to correspond to the shape of a heating wedge of a film welding machine, such that it can replace the heating cartridge and the hot wedge of a conventional film welding device. It is preferably produced from a conductive ceramic material and is distinguished by uniform heat distribution, good thermal conductivity and resistance to wear, as well as by excellent corrosion resistance.

### TECHNICAL FIELD OF INVENTION

The invention relates to an electrical heating element, in particular for a hot-wedge film welding device, having two electrodes and a heating resistor arranged between the electrodes such that an application of an electrical voltage to the electrodes results in heat being produced along the length of the heating resistor, with the heating resistor being made from a corrosion-resistant material and having a top side and a bottom side opposite from the top side, with both sides of the heating resistor converging at an acute angle.

### DISCUSSION OF RELATED ART

Electrical heating elements as such are known and are used in a wide variety of implementations for a wide variety of applications. They are also used, for example, in welding devices for overlap welding of webs of plastic film where, at their surfaces to be joined, due to the effect of the temperature, the webs are heated by a hot wedge, are plastified and/or melted, and are then positively connected by means of pressure rollers due to the effect of pressure. In this process, the hot wedge is guided between the webs of film that contact each other. Common welding wedges are made of metal, primarily because of its good thermal conductivity characteristics, and are heated to a temperature above the melting temperature of the web of plastic film by means of the electrical heating element that engages the hot wedge, thereby establishing contact, or is embedded in it.

Due to the high temperatures required for the welding of PVC film, aggressive hydrogen chlorides are released during the welding process. In combination with moisture they form acids that lead to corrosion and local destructive damage of the hot wedge and the electrical heating element which, in turn, has a negative effect on the quality of the welding seams. In daily use, the hot wedge and the heating element are subject to high corrosive as well as mechanical stresses and need to be replaced after a certain length of working life.

### SUMMARY OF THE INVENTION

The invention therefore addresses the problem of proposing a heating element in combination with a hot wedge that, compared with the prior art, has a higher mechanical wear resistance as well as a better corrosion resistance in order to make a longer useful life possible.

According to the invention, this problem is solved by an electrical heating element with the characteristics of claim 1. Additional advantageous embodiments are given in the subclaims.

According to the invention, the heating resistor is produced by using an electrically conductive ceramic material. The ceramic material by itself may form the heating resistor, or it may be applied as a coating to a metallic heating resistor. Ceramic materials like SiC or MoSi₂—Al₂O₃ for example may be used that have not only excellent properties regarding corrosion resistance, wear resistance, and thermal conductivity, but have above all a high electrical conductivity as well. The conductivity of the ceramic material, and therefore the flow of current through the heating resistor, can be influenced by changing the portions of its conductive and non-conductive components.

One top side and one bottom side of the heating resistor converge at an acute angle. Thus, the heating resistor has essentially the contour of a conventional hot wedge, which has the effect that the heating resistor can assume its function, too. This has the advantage that the heat transfer from the electrical heating element to the plastic film is direct and therefore more effective. In addition, the indirectly heated hot wedge that consists of a separate part in conventional hot wedge film welding devices is eliminated, resulting in a reduction of the manufacturing and maintenance costs. As an additional advantage, the heat distribution on the “wedge-shaped” heating resistor is considerably more uniform than on the conventional hot wedge that is heated indirectly via heating cartridges.

The heating resistor may have one or more windings or folds along its length. Accordingly, its length is a multiple of its height and width, with the resulting effective cross-sectional narrowing having the effect of determining the resistance value for the current flow. Besides the selected geometry factor, the current flow may also be influenced by an appropriate selection of material, i.e. by varying the conductivity of the material of which the heating resistor is made.

In an advantageous implementation of the invention, the heating resistor is made homogeneously in one piece from an electrically conductive ceramic material. This ensures a fast and uniform heat distribution in the heating resistor and reduces its material costs during its manufacture. The one-piece ceramic heating resistor can be cast in its purpose-designed shape that may consist of meandering windings or folds, for example. In this process, the electrodes can be enclosed with positive surface-to-surface contact, resulting in a good mechanical and electrical connection.

In another preferred implementation of the invention, the heating resistor has a core made of metal or a metal alloy, and a ceramic coating. For this purpose, a corrosion-resistant chromium nickel steel or a similar material may be used, for example. It is also possible to make the metallic core of the heating resistor from baser materials. The ceramic coating improves the surface of the metallic core and acts as a protective coating. It encases the core with positive surface-to-surface contact which makes a good mechanical and electrical connection possible. The core of the coated heating resistor can be made in a simple way from a metal block by means of cutting methods commonly used in industry.

Compared with conventional hot wedges, the ceramic or ceramically coated “wedge-shaped” heating resistor has a wear and corrosion resistance that is multiple times higher. At the same time, its adhesiveness for plastic melt residues is lower which makes for an easier sliding of the heating resistor between the webs of film. In addition, with a ceramic heating resistor, a conversion for different types of plastic films, as is often required for conventional metallic welding wedges, is not necessary.

Preferably, with the heating resistor according to the invention, the electrodes are arranged laterally on the heating resistor in an area that is remote from the tip of the heating resistor. In this way, the heating resistor can be inserted without problems between the webs of plastic material that are to be welded, and can be moved with ease in their longitudinal direction.

It proved to be of particular advantage to provide attachment elements on the electrodes for fixing the heating resistor on the welding device. In the simplest case, these may consist of through-holes in the electrodes. In this way, there is no need for separate attachment elements, which simplifies the production process of the electrical heating element and leads to a higher mechanical wear resistance.

In the following, the invention is explained in detail with reference to two implementations shown in the drawing. Additional characteristics of the invention are given in the following description of the implementations of the invention in conjunction with the claims and the attached drawing. In different implementations of the invention, the individual characteristics may each be implemented by themselves or in combinations of several.

### BRIEF DESCRIPTION OF THE DRAWINGS

FIG. 1 shows a heating resistor according to the invention with a winding configuration in a perspective view; and

FIG. 2 shows a heating resistor according to the invention with a folded configuration in a perspective view.

### DETAILED DESCRIPTION OF THE INVENTION

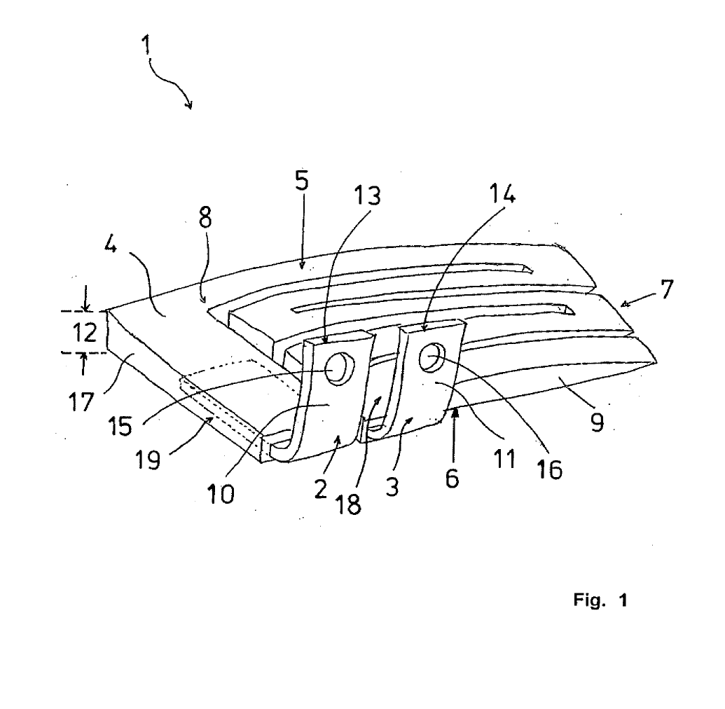

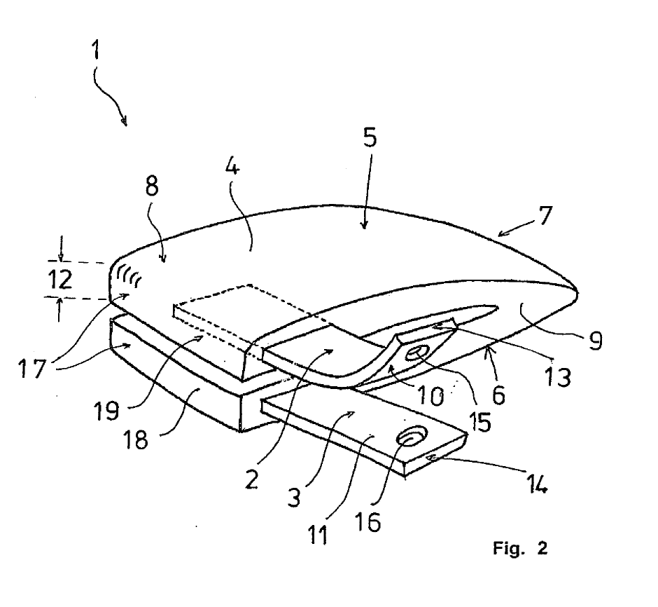

The heating elements 1 according to the invention shown in FIGS. 1 and 2 include two electrodes 2, 3 and a heating resistor 4 connected in an electrically conductive way with the electrodes 2, 3. The heating resistor 4 has a wedge-shaped contour with a top side 5 and a bottom side 6 that converge at an acute angle and end in a tip 7.

The electrodes 2, 3 are arranged in an area 8 of the heating resistor 4 that is remote from the tip 7, and extend laterally from a side surface 9 of the electrical heating element 1. They have a flat, rectangular cross-sectional shape and run in a plane perpendicular to the bottom side 6 and parallel to the side surface 9 of the heating resistor 4. The limbs 10, 11 of the electrodes 2, 3 extend beyond the top side 5 of the heating resistor 4 by a multiple of its thickness 12 and have at their upper ends 13, 14 holes 15, 16 as attachment elements for fixing the heating element 1 on a welding device that is not shown in the drawing.

The heating resistor 4 of the electrical heating element 1 is made of an electrically conductive ceramic material and has a wedge-shaped contour with a flat, elongated shape and a rear edge 17 from which the heating resistor 4 extends in the direction of the front tip 7 of the heating element 1 and back again to the rear edge 17. In the area 8 at the rear edge 17 that is remote from the tip 7, the electrodes 2, 3 are embedded with positive surface-to-surface contact in the ends 18, 19 of the heating resistor 4, being connected in an electrically conductive way with the heating resistor.

FIG. 1 shows an electrical heating element 1 whose heating resistor 4 is configured with meandering windings. Its heating resistor 4 extends several times from the rear edge 17 to the front tip 7 of the heating element 1 and back again. In contrast, FIG. 2 shows a heating element 1 with a folded heating resistor 4. This is folded once and extends from the rear edge 17 to the front tip 7 and back again to the rear edge 17 of the electrical element 1. The top side 5 and the bottom side 6 of the heating resistor 4 are preferably uniformly flat, i.e. without uneven areas.

1. An electrical heating element, in particular for a hot-wedge film welding device, having two electrodes and a heating resistor arranged between the electrodes such that an application of an electrical voltage to the electrodes results in heat being produced along the length of the heating resistor, with the heating resistor being made from a corrosion-resistant material and having a top side and a bottom side opposite from the top side, with both sides of the heating resistor converging at an acute angle, wherein the heating resistor is produced by using an electrically conductive ceramic material.

2. An electrical heating element according to claim 1, wherein the heating resistor is made homogeneously in one piece from an electrically conductive ceramic material.

3. An electrical heating element according to claim 1, wherein the heating resistor has a core made of metal or a metal alloy, and a ceramic coating.

4. An electrical heating element according to claim 1, wherein the electrodes are arranged laterally on the heating resistor in an area that is remote from the tip of the heating resistor.

5. An electrical heating element according to claim 1, wherein the electrodes have attachment elements for locking the heating resistor in position.
